(19) United States
(12) Patent Application Publication
(10) Pub. No.: US 2025/0252409 A1
(43) Pub. Date: Aug. 7, 2025

(54) SYSTEM AND METHOD FOR ON-DEMAND ELECTRONIC DEVICE CIRCULATORY TRANSPORT BY IN-DEVICE EMBEDDED APPLICATION

(71) Applicant: Sustronics LLC, Longview, TX (US)

(72) Inventor: Jose Reyes, Longview, TX (US)

(21) Appl. No.: 19/186,022

(22) Filed: Apr. 22, 2025

Related U.S. Application Data
(63) Continuation-in-part of application No. 18/385,646, filed on Oct. 31, 2023.
Application No. 18/385,646 is a continuation of application No. 16/692,230, filed on Nov. 22, 2019, now Pat. No. 11,803,821.
(60) Provisional application No. 62/771,033, filed on Nov. 24, 2018.

(51) Int. Cl. G06Q 50/04; G06F 1/16; G06Q 10/20; G06Q 10/30; G06Q 20/02; G06Q 20/10; H02J 50/23; H02J 50/27; H04L 67/12; H04L 67/141; H04L 67/51; H10K 71/00; H10K 102/00

(52) U.S. Cl. CPC G06Q 10/30; H04L 67/52; Y02W 30/82

(57) ABSTRACT

There are disclosed systems and methods for transport using an end-of-life circularity transport application installed in an electronic device. In an embodiment, a method includes accessing an application server from a communications device of an operator of the electronic device, the communications device having a processor for operating an end-of-life circularity transport application installed on the processor. The method includes determining a location relating to the transport service on a computing device. The method includes receiving a transport request from a user, the transport request specifying at least one of a pick-up region or a drop-off region. The method includes determining one or more locations of interests within the at least one of the pick-up region or the drop-off region. Other embodiments are also disclosed.

### REFERENCE TO PENDING PRIOR PATENT APPLICATION

This patent application is a continuation-in-part of pending prior U.S. patent application Ser. No. 18/385,646, filed Oct. 31, 2023 by Jose Reyes for METHOD FOR DEMANUFACTURING ELECTRONIC DEVICES, which in turn is a continuation of U.S. patent application Ser. No. 16/692,230, filed Nov. 22, 2019, now U.S. Pat. No. 11,803,821, which claims priority to U.S. Provisional Application No. 62/771,033 filed on Nov. 24, 2018 and entitled SUSTAINABLE ELECTRONIC DEVICES, the entire contents of Application 62/771,033.

The above-identified patent applications are hereby incorporated herein by reference.

### TECHNICAL FIELD

Embodiments described herein pertain generally to a system and method for providing on-demand electronic device (“device”) pickup services through use of an embedded app in the device.

### BACKGROUND

Billions of pounds of electronic waste (e-waste) are generated annually from electronic devices that fail or that reach an end-of-life, from the perspective of their operators, and often wind up in landfills or dumped in the ocean. Although a vast array of electronic devices are produced inexpensively, the appeal and features of next generation products quickly render the devices obsolete. Furthermore, the permanent fasteners and component integration used in manufacturing the devices discourage repair and prevent demanufacturing down to the component level. Also, a lack of repair and recycling information means that many end-of-life devices end up stockpiled in the closets and basements of their owners.

One solution to e-waste has been the availability of community recycling centers. Also, e-waste applications (Apps) exist which provide a directory of drop-off locations and recycling organizations. Unfortunately, recycling drop-off is a one-way, non-interactive process, and does not facilitate repair or refurbishing of obsolete devices, nor a more sophisticated scrapping of valuable components such as gold or still-working components. Only 15-20% of e-waste is recycled, resulting in heavy metals and other toxins being diverted into the air, water, and land, impacting future generations' ability to meet their basic needs.

Currently, devices that reach end-of-life (EOL) do not have built in apps that facilitate a device owner being able to return their device without having to leave their location. Such devices typically are not communicative to entities wanting the device for repairing, recycling or remanufacturing in an environmentally friendly way. Although some on-demand services are available for transporting passengers or food, none are being used to help move EOL devices into more environmentally friendly venues thereby reducing pollution such as electronic waste (e-waste). E-waste typically consists of laptop computers, smart phones, televisions, gaming devices, smart watches among others. In general, e-waste may be considered anything with an electrical plug and or a battery.

### SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

In an embodiment, there is provided a method for transport using an end-of-life circularity transport application installed in an electronic device, the method comprising: accessing an application server from a communications device of an operator of the electronic device, the communications device having a processor for operating an end-of-life circularity transport application installed on the processor and providing internet connectivity to the application server, the end-of-life circularity transport application capable of one or both of (1) driving a user interface configured to provide a set of transport instructions and (2) provide the transport instructions configured to a transport service; determining a location relating to the transport service on a computing device, the method being performed by one or more processors and comprising: receiving a transport request from a user, the transport request specifying at least one of a pick-up region or a drop-off region; determining one or more locations of interests within the at least one of the pick-up region or the drop-off region; comparing the at least one of the pick-up region or the drop-off region with one or more previous locations related to the user; and determining a likely location based on the determined one or more locations of interest and the one or more historical locations.

In another embodiment, there is provided a computing device comprising a display; one or more memory resources; one or more processors coupled to the display and the one or more memory resources, the one or more processors to: access an application server having a processor for operating an end-of-life circularity transport application installed on the processor and providing internet connectivity to the application server, the end-of-life circularity transport application capable of one or both of (1) driving a user interface configured to provide a set of transport instructions and (2) provide the transport instructions configured to a transport service; receive a transport request for a transport service from a user, the transport request specifying at least one of a pick-up region or a drop-off region; determine one or more locations of interests within the at least one of the pick-up region or the drop-off region.

Other embodiments are also disclosed.

Additional objects, advantages and novel features of the technology will be set forth in part in the description which follows, and in part will become more apparent to those skilled in the art upon examination of the following, or may be learned from practice of the technology.

### BRIEF DESCRIPTION OF THE DRAWINGS

Non-limiting and non-exhaustive embodiments of the present invention, including the preferred embodiment, are described with reference to the following figures, wherein like reference numerals refer to like parts throughout the various views unless otherwise specified. Illustrative embodiments of the invention are illustrated in the drawings, in which:

FIG. 1a illustrates a perspective view of an electronic device with locking mechanisms releasable by a recycling tool, in accordance with an embodiment of the present disclosure.

FIG. 1b illustrates a cutaway view of the locking mechanism of FIG. 1a, in accordance with an embodiment of the present disclosure.

FIG. 2 illustrates a perspective view of an upper and a lower portion of an enclosure of the electronic device of FIG. 1a, in accordance with an embodiment of the present disclosure.

FIGS. 3a and 3b illustrate a perspective view of a peelable display mountable to a frame of the enclosure of the electronic device, in accordance with an embodiment of the present disclosure.

FIGS. 4a and 4b illustrate a perspective view of a hook-and-loop fastener for mounting internal components to the enclosure of the electronic device, in accordance with an embodiment of the present disclosure.

FIG. 5 illustrates a schematic of a wireless power receiver, in accordance with an embodiment of the present disclosure.

FIG. 6 illustrates a perspective view of internal components of the electronic device, in accordance with an embodiment of the present disclosure.

FIG. 7 illustrates a network diagram of an end-of-life application for exchanging one or more components of the electronic device, in accordance with an embodiment of the present disclosure.

FIG. 8 illustrates a logic diagram for the end-of-life application of FIG. 7, in accordance with an embodiment of the present disclosure.

FIG. 9 illustrates an activity flow of the end-of-life application, in accordance with various embodiments of the present disclosure.

FIG. 10 illustrates a demanufacturing procedure for the electronic device, in accordance with one embodiment of the present disclosure.

FIG. 11 illustrates a network diagram of an end-of-life application for transportation the electronic device, in accordance with an embodiment of the present disclosure.

FIG. 12 illustrates the end-of-life application of FIG. 11 providing circularity for environmental impact for device transport.

### DETAILED DESCRIPTION

Embodiments are described more fully below in sufficient detail to enable those skilled in the art to practice the system and method. However, embodiments may be implemented in many different forms and should not be construed as being limited to the embodiments set forth herein. The following detailed description is, therefore, not to be taken in a limiting sense.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

As may be appreciated, based on the disclosure, there exists a need in the art for a method of designing, manufacturing, and demanufacturing an electronic device such that it can be easily disassembled for the repair, refurbishing, recycling, or scrapping of its useful elements when it has failed or become obsolete. Further, there exists a need in the art for extending the lifetime of the electronic device and recovering the useful elements such that the manufacturing of said devices moves in the direction of environmental sustainability. In addition, there exists a need in the art for facilitating a 2-way exchange among parties interested in extending device lifetime and recovering the useful elements.

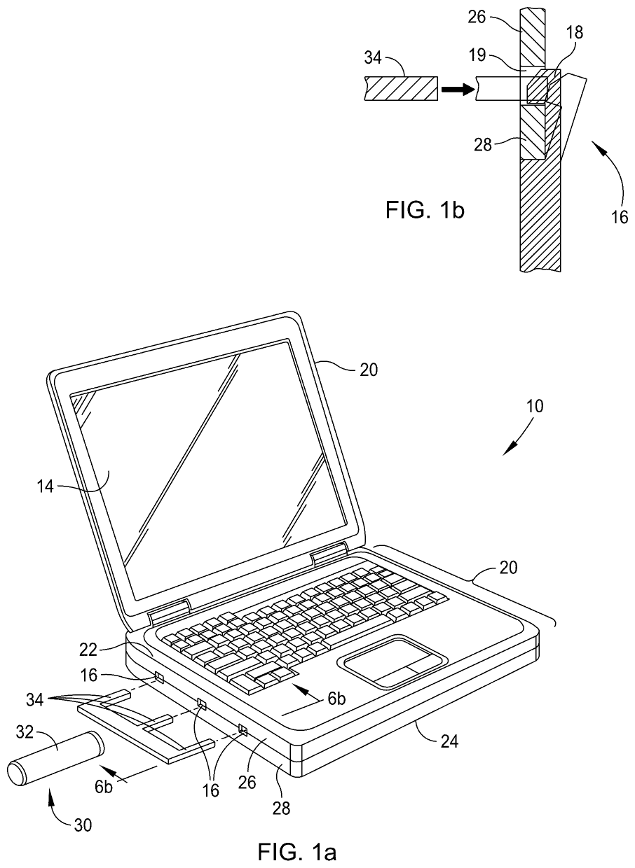

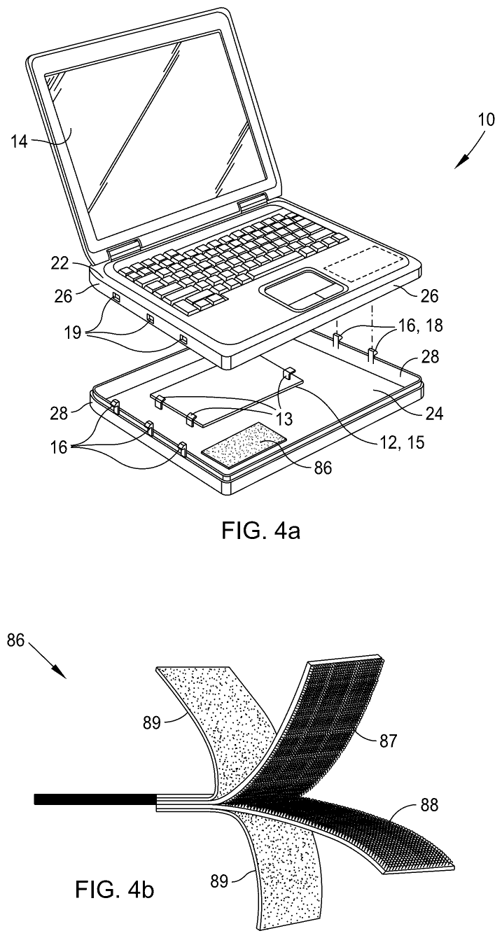

In an embodiment, referring to FIGS. 1a-1b, 2, 4a, and 6, a method for demanufacturing an electronic device 10 is described for minimizing an environmental impact and to facilitate a repair, refurbishing, or recycling of the electronic device 10 at an end-of-life. The electronic device may be a laptop computer, a smart phone, a tablet, a camera, an Internet of Things device, a television, a gaming device, and a smart watch. The method may comprise providing an internal component 15 and a display 14 for manufacturing the electronic device 10. The internal component 15 may be a motherboard 12 (FIG. 4a), one or more batteries (not shown) for powering the motherboard, a wireless power receiver for charging the one or more batteries, a shielding enclosure, an input/output device, a hard drive, or a memory.

At least one of the component 15 and the display 14 may be flexible such that they may be peelably removable from the enclosure by peeling off at the end-of-life of the electronic device. The method may further comprise enclosing the component 15 within and attaching the display 14 to an enclosure 20 having a top portion 22 and a bottom portion 24 and one or more side walls 26, 28 for joining the top 22 and the bottom 24 portions. Upper side wall 26 and lower side wall 28 may be extensions of top portion 22 and bottom portion 24, respectively, and may be configured to directly join top portion 22 to bottom portion 24 in order to assemble the enclosure 20. Alternatively, side walls 26 and 28 may be separate pieces linkable to the top 22 and the bottom 24 portions, respectively, for completing the enclosure 20.

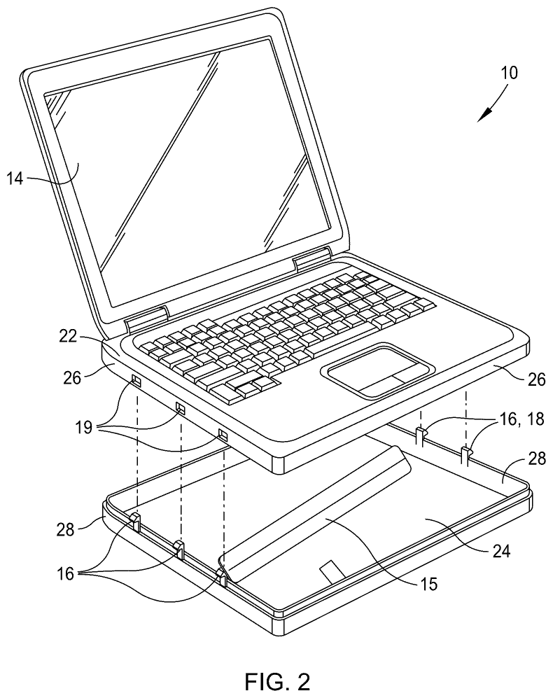

Continuing with FIGS. 1a-1b and 2, at least two locking mechanisms 16 may be disposed on one of the one or more side walls 26, 28 for locking the top 22 and the bottom 24 portions together. The locking mechanism 16 may comprise a hook receptacle 19 disposed on top portion 22 and a mechanism hook 18 complementary to the hook receptacle 19 and disposed on the bottom portion 24. Mechanism hook 18 may cantilever out from hook receptacle 19, as shown in FIG. 1b, during latching and unlatching of the locking mechanism 16. Alternatively, the hook 18 may be disposed on top portion 22 with the receptacle 19 disposed on bottom portion 24. In other embodiments, there may be only one locking mechanism 16 disposed on one or more of the one or more side walls 26, 28. Two or more locking mechanisms 16 may alternatively be disposed on two or more of side walls 26, 28.

Referring to FIGS. 1a-1b, in one embodiment, three of the locking mechanisms 16 on a side wall may be simultaneously releasable by one action of the prongs 34 of a recycling tool 30 inserted into locking mechanisms 16. In other embodiments, at least two of the locking mechanisms 16 on a side wall may be simultaneously releasable by one action of the recycling tool 30. Recycling tool 30 may assist in rapidly disassembling enclosure 20 by a pushing action from handle 32 pressing prongs 34 into hook receptacles 19. Advantageously, the pushing action of tool 30 avoids a repetitive unscrewing action of an enclosure locked together by screws, and avoids prying apart an enclosure 20 that has been glued or snapped together. In other embodiments, recycling tool 30 may have one prong, or may have two or more prongs for simultaneously releasing locking mechanisms 16.

In embodiments not shown, each locking mechanism 16 may comprise a tab, a magnet, a fingerprint sensor, a pin, a snap-lock mechanism, a press-fit mechanism, a bracket-type mechanism, a slide-and-lock mechanism, a twist-and-lock or other friction-fit mechanism, a frequency-triggered release mechanism, a tongue-and-groove mechanism, a buckle mechanism, a joint, a hinge, or any other suitable mechanism for securing the top and bottom portions in a way releasable with one action of the recycling tool 30. Advantageously, the use of a push release, single-action locking mechanism and tool may alleviate the risk of worker injury, such as carpal tunnel syndrome arising from repetitive hand and wrist actions.

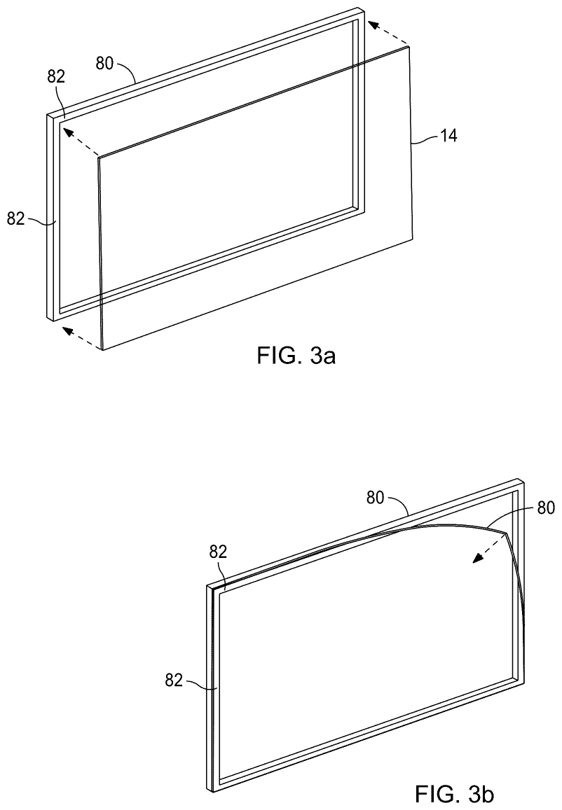

Referring now to FIG. 3a-3b, in an embodiment, display 14 may be flexible, and may be peelably attached to display frame 80 at contact surface 82 (FIG. 3a) using one or more of a hook-and-loop fastener, a heat-sealable fabric, a resilient glue, and mechanical snaps. Display 14 may be peeled off from contact surface 82 (FIG. 3b) during demanufacturing, and may be replaced with a new display, or may be recycled. Display frame 80 may be connected to the enclosure 20 via a hinge, such as for a laptop computer or related device, or may be part of or internal to enclosure 20 of the electronic device 10. Alternatively, display frame 80 with contact surface 82 may be integral to the enclosure 20 and may be isolated in FIGS. 3a-b only for the purpose of defining contact surface 82.

Continuing, in various embodiments, display 14 may be an organic light-emitting diode (OLED) display, and the OLED display may be flexible for peelably attaching to enclosure 20 or to display frame 80 for easy repair or recycling. The OLED may be built from organic electroluminescent materials resulting in a display that may be thinner and lighter than an LED or LCD, and may therefore be flexible to facilitate peelable attaching. Because individual pixels of the OLED can be shut off to provide an absolute black, they may have lower power consumption and thereby facilitate a smaller power supply (not shown) for the electronic device. Display 14 may also be a light-emitting polymer (LEP), or may be a flexible organic light-emitting diode (FOLED) having a flexible plastic substrate.

Referring now to FIG. 4a-4b, in various embodiments, motherboard 12 may attach to enclosure 20 by one or more guides of the enclosure 20 and may be slidably removable at the end-of-life of the electronic device. The one or more guides may comprise guide tabs 13 or one or more of a guide rail (not shown). Guide tab 13 may be an L-shaped hook or tab for cupping an edge of the motherboard 12. Motherboard 12 may be rigid, such as an FR4 epoxy printed circuit board. Guides 13 provide for quick demanufacturing and/or repair of electronic device 10.

In alternative embodiments, motherboard 12 may be flexible for peelable attachment to enclosure 20 using one or more of a hook-and-loop fastener, a heat-sealable fabric, a resilient glue, and mechanical snaps, or other quick-release non-damaging fastener. Glue may be resilient if it retains its elasticity or stickiness for months or years after attachment, such as various tearable rubbery adhesives, or such as 3M's Photomount™ product. Hook-and-loop fastener 86 may comprise hooking pad 87, looping pad 88 removably attachable to hooking pad 87, and an upper and lower layer of adhesive 89 for adhering one to the enclosure 20 and the other to the component 15 being mounted. Other internal components 15 may be peelably attachable to enclosure 20 for quick demanufacturing and may include one or more batteries for powering the motherboard, a wireless power receiver for charging the one or more batteries, a shielding enclosure, an input/output device, a hard drive, a processor, a memory, and a heat sink.

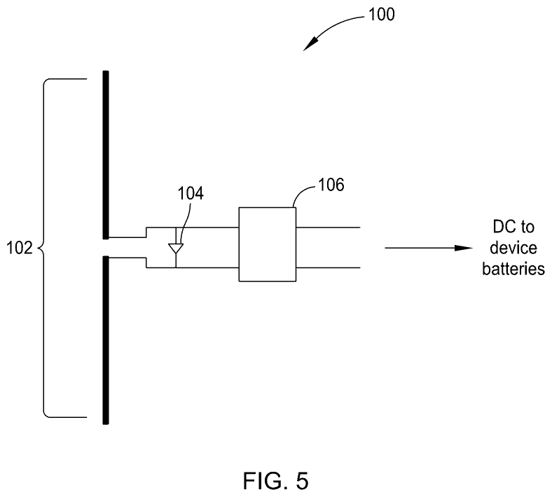

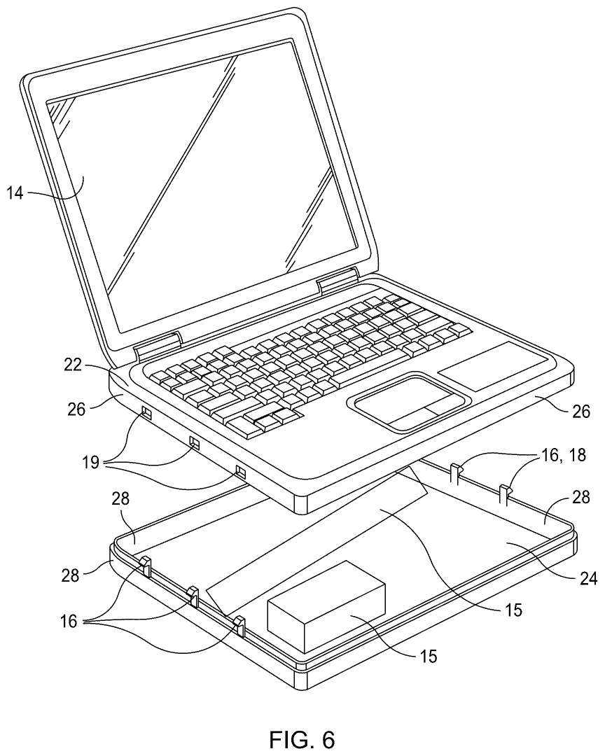

Referring now to FIG. 5, in an embodiment, the method for demanufacturing the electronic device 10 may also comprise providing one or more batteries (not shown) within the enclosure 20 for powering the motherboard 12, and may further comprise providing a wireless power receiver 100 connectable to the one or more batteries for charging from an RF source (not shown) remote from the electronic device 10. The one or more batteries and the wireless power receiver 100 may each be represented as component 15 depicted in FIG. 6, and may peelably or slidably attachable to enclosure 20. Wireless power receiver 100 may comprise a rectenna comprising an antenna 102 feeding a rectifying circuit 104 and 106 capable of providing DC power to the one or more batteries.

The RF source may be one of a WiFi router and a directional wireless charging transmitter configured to communicate with the wireless power receiver 100. Electronic device 10 may be equipped with a locator chip (not shown) communicative with the directional charging transmitter, and may facilitate wirelessly charging the electronic device at distances much greater than may typically be encountered with the wireless chargers made for electric toothbrushes and smart phones. The locator chip may send out a beacon signal receptive by the charging transmitter. The directional charging transmitter may determine the propagation paths emanating from the locator chip, or otherwise determine the location of the electronic device, and may then concentrate power to the wireless power receiver 100 for charging the electronic device 10. Beneficially, an electronic device using an OLED display and other reduced power methods may derive adequate power for partially or completely charging an electronic device 10 from the wireless power receiver 100.

Referring again to FIGS. 1a-1b, in various embodiments, the method for demanufacturing may further include, once all internal components have been mounted to enclosure 20, completing the assembly of the electronic device 10 by locking the top portion 22 to the bottom portion 24 with locking mechanisms 16, thereby completing the enclosing process. The method may further include making available at least one of demanufacturing instructions and the recycling tool 30 for demanufacturing (disassembling) the device 10. Demanufacturing instructions may be one or more of information describing how to use the recycling tool, schematics or mechanical drawings useful to an entity repairing or recycling the electronic device, and contact information for repair or recycling entities.

The recycling tool and/or demanufacturing instructions may be made available to repair entities approved by the manufacturer or to all buyers and/or operators of the electronic device. Approved entities may be internal to the manufacturer, or may be designated or approved repair or recycling entities external to the manufacturer.

A motherboard may be defined as including a primary electrical circuit, circuit board, and/or integrated circuit necessary for the primary function of the electronic device. For example, the motherboard for a laptop computer may include a processor and memory for executing the operating software and driving the display of the computer. A flexible motherboard may be constructed on thin, lightweight substrates that minimize material usage, production cost, and carbon dioxide emissions during manufacturing, thereby promoting sustainability. A flexible motherboard may be bent, stretched, or folded, and may thereby facilitate non-planar enclosures (component 15 in FIG. 2) that minimize material usage or are curved. Flexible boards may be printed on plastic or rubber film. Examples of plastic film may be polyimide polymers (e.g. commercial product Kapton) or fluoropolymers like Teflon.

The top 22 and the bottom 24 portions of enclosure 20 may be made of metal, metal alloys, or plastic or a combination such as are well-known in the art. For example, a plastic top or bottom portion may be made of thermoplastic, resin, polymer, or combinations thereof. The mechanism hook 18 and receptacle 19 may be conductive or coated with a conductive film for electrically connecting the top and bottom portions of the enclosure, and may thereby provide RF shielding for the enclosure 20.

The hook-and-loop fasteners 87 and 88 used to attach one or more internal components 15 to enclosure 20 may include conductive material (not shown) for electrically connecting the one or more internal component to the enclosure. For example, the hook-and-loop fasteners 87 and 88 may be made of or coated with the conductive material. Internal component 15 may include a conductive shield for attenuating radio emissions emanating from or radiating into the internal component 15. The conductive shield may comprise a metallic enclosure (not shown) around part or all of circuitry of the internal component 15, and the conductive shield may then be electrically connected to the enclosure 20 by the conductive hook-and-loop fastener. The device 10 may also include one or more electromagnetic interference (EMI) gaskets operably connected to at least one of the top portion 22, the bottom portion 24, the upper side wall 26, and the lower side wall 28 of the enclosure 20. The one or more EMI gaskets may be a flexible conductive plastic or metal and may be sandwiched between internal component 15 and the enclosure 20, or may be sandwiched between two of portions 22 and 24 and side walls 26 and 28.

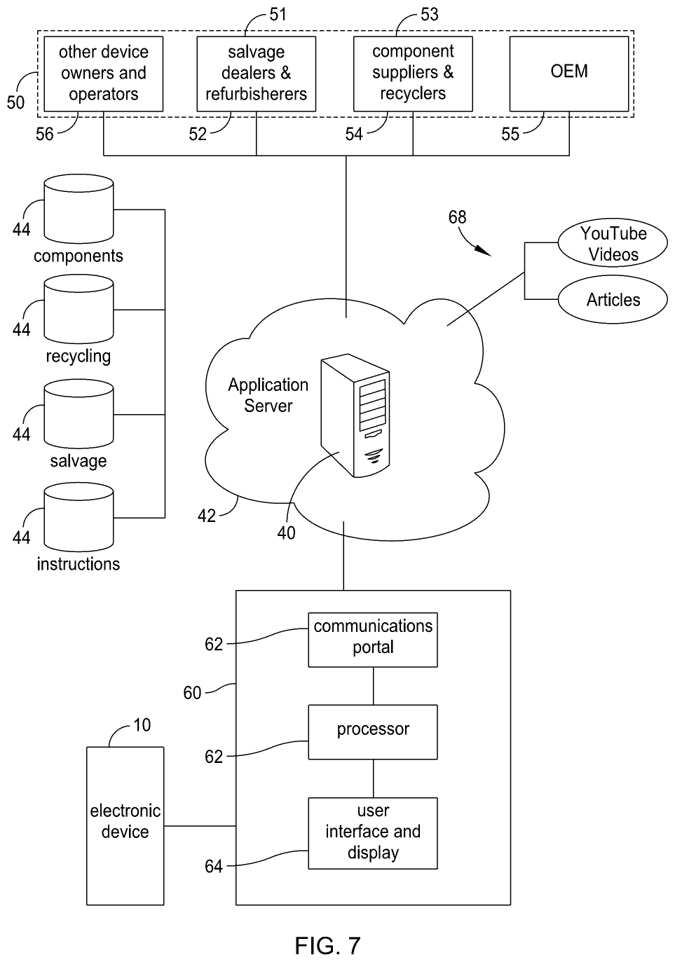

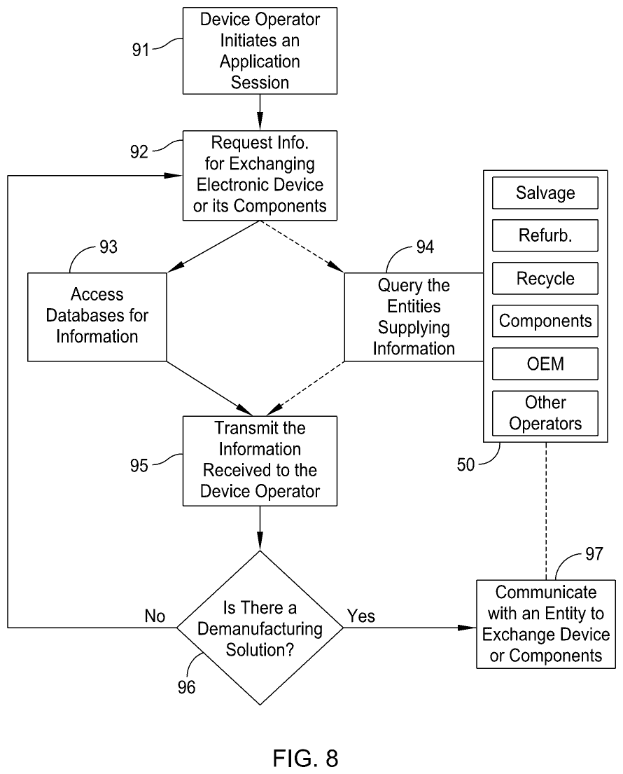

Referring now to the network diagram of FIG. 7 and the logic diagram of FIG. 8, in various embodiments, there is described a method for exchanging one or more components of an end-of-life electronic device 10 between a device operator owning or operating the electronic device and a network of entities 50 in order to recycle device scrap of the end-of-life electronic device or to extend the life of the device.

The exchange method may comprise initiating 91, through an executable end-of-life application, a logical session between the device operator and an application server 40 accessible through the internet 42. The executable application may be installed on a processor 62 of a communication device 60 of the device operator and may access the application server 40 via a communication portal 66 connected to the internet 42. The processor 62 may drive a user interface and display 64 for interacting with the device operator. Alternatively, the executable application may be integrated into or installed on the electronic device 10 itself, or may be integrated into the motherboard of the device. Advantageously, including the application in the electronic device itself installs longevity and sustainability into the device, and may be installed at the point of manufacture. Communication portal 66 may be an internet modem, WiFi router, cellular transceiver, or other means commonly used to access the internet.

The exchange method may further comprise receiving from the device operator a request 92 for information regarding one or more of a demand for a scrap article of the end-of-life electronic device, a list of refurbishers, a list of recycling entities, and a price and availability of a repair component. The method may further comprise accessing 93 databases 44 connected to the application server 40 to retrieve the information arriving from at least one of the following entities communicative with the application server 40: a salvage dealer, a refurbisher, a recycling entity, and a component supplier.

The executable application may periodically receive from the entities 50 communicative with the server 40 and from communication device 60 of the device operator an update of supply and demand values of the one or more components for a set of makes and models of the electronic device supported by the databases 44 connected to the application server 40. The values may include price and availability. The entities 50 communicative with the application server 40 may also include at least one of an original equipment manufacturer (OEM) supplier 55 and other device operators 56. The exchange method may also comprise querying 94 the entities directly to fulfill the information request 92.

Finally, the method may include transmitting 95 to the device operator the information retrieved, where the requested information may be retrieved directly or indirectly from the network of entities 50. The method may further comprise deciding 96 whether there is an actionable demanufacturing solution, based on the information retrieved. If there is an actionable solution, the method may further comprise communicating 97 with one or more of the entities to transfer (exchange) one or more components of the end-of-life device. The component transfer may comprise a reciprocal transacting of funds through the application server in order to complete the exchange of the one or more components.

Continuing with FIGS. 7 and 8, the databases 44 connected to the application server 40 may include demanufacturing instructions for at least one of disassembling, scrapping, recycling, and refurbishing the electronic device, and the request 92 for information may include the demanufacturing instructions. The demanufacturing instruction may include pointing to education links 68 including one or more of YouTube videos, articles, and OEM and component supplier price and availability data. If the deciding 96 determines that there is not an actionable demanufacturing solution, the method may further include requesting 92 different information or the same information at a later time.

Beneficially, users of the executable application may quickly assess demanufacturing options through a transparent exchange of information between one or more of the device operators, the salvage dealer, the refurbisher, the recycling entity, the component supplier, and the OEM. Once distributed to a sufficiently large number of users, the end-of-life application provides an impetus to move millions of end-of-life electronic devices stored, for example, in closets and basement into a commercial stream of entities communicative with the application server executing one or more of scrapping, recycling, refurbishing, repair, manufacturing, and retail exchange.

The end-of-life application may include an account setup and login routine to generate the network of entities and to thereby facilitate an economic exchange currently not available in the demanufacturing and recycling environment. Some electronic devices may become obsolete, from the perspective of their owners or operators, because their appearance becomes marred. These marred or obsolete devices may have utility in other markets, or may be upgraded by refurbishers (remanufacturing) to be attractive and renewed in performance. Refurbishers may include non-profits who resell the electronic devices essentially unchanged to markets where the end-of-life devices are viewed as attractive in their appearance and modern in their performance.

Demanufacturing most directly may comprise the partial or complete disassembling of the electronic device into its basic internal components and subassemblies within or disposed on the enclosure, and may be a first step to repair, refurbishing, or recycling. A method for demanufacturing may also include design and manufacturing steps and elements that facilitate or expedite the repair, refurbishing, or recycling of the electronic device, and whose steps and elements may minimize the natural resources consumed and pollution released into the environment. Establishing a 2-way network of exchange of device components and demanufacturing instructions, through the end-of-life application, may extend the life of the electronic device and dramatically reduce e-waste, and may thereby inject a new ethos of design-for-sustainability into the electronic devices market.

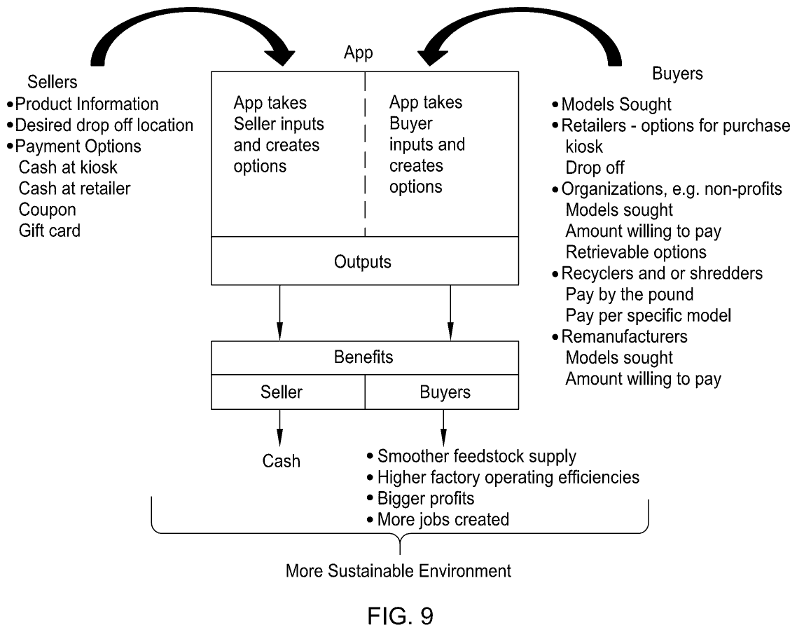

FIG. 9, in one embodiment, illustrates activities for any user of the end-of-life application which may include the device operators, the salvage dealer, the refurbisher, the recycling entity, the component supplier, and the OEM. The application may comprise receiving seller inputs (or values) from a user selling any component or an entire device, the values comprising one or more of a sold product description, product make and model, an available quantity, a selling price, a seller drop-off location, and payment instructions. The application may further comprise receiving buyer inputs (values) from any user seeking to buy any component or the entire device, the values comprising the make and models sought, a quantity sought, the selling organization being sought, a buyer drop-off location, an offered price, and payment instructions. The benefits of such an application network include a flow of cash, increased manufacturing efficiencies, and a levelized feedstock of components and working devices.

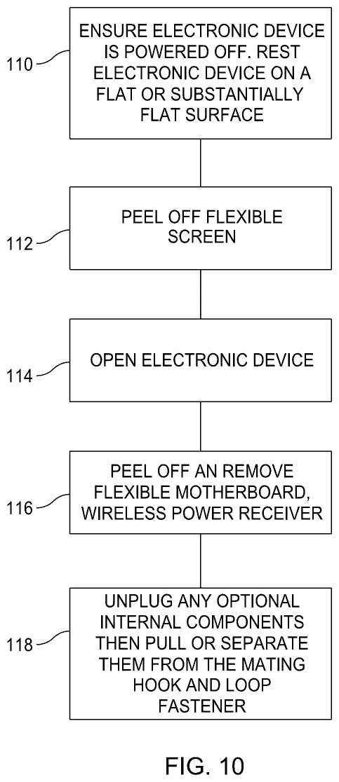

Referring now to FIG. 10, in one embodiment, a process for demanufacturing the electronic device may comprise 110 powering off the device and laying it flat for disassembly, peeling off 112 the flexible screen 14 if attached to the outside of the enclosure 20, and opening 114 the electronic device. The demanufacturing process may further comprise peeling off 116 one or more of a flexible motherboard, the wireless power receiver, and any other peelable internal component. The method may further comprise unplugging any internal component mounted by a hook-and-loop fastener.

### Circularity App

Circularity relates to an economic model design to eliminate waste and keep resources in use for as long as possible. Circularity involves design for longevity with creation of products that can last longer and can be easily repaired. It involves reuse and refurbishing products again or restoring them to good condition. Remanufacturing and rebuilding products to a like-new state is part of circularity as sustainable source management. Resource efficiency with the use of resources to reduce waste and conserve energy is an important part of circularity.

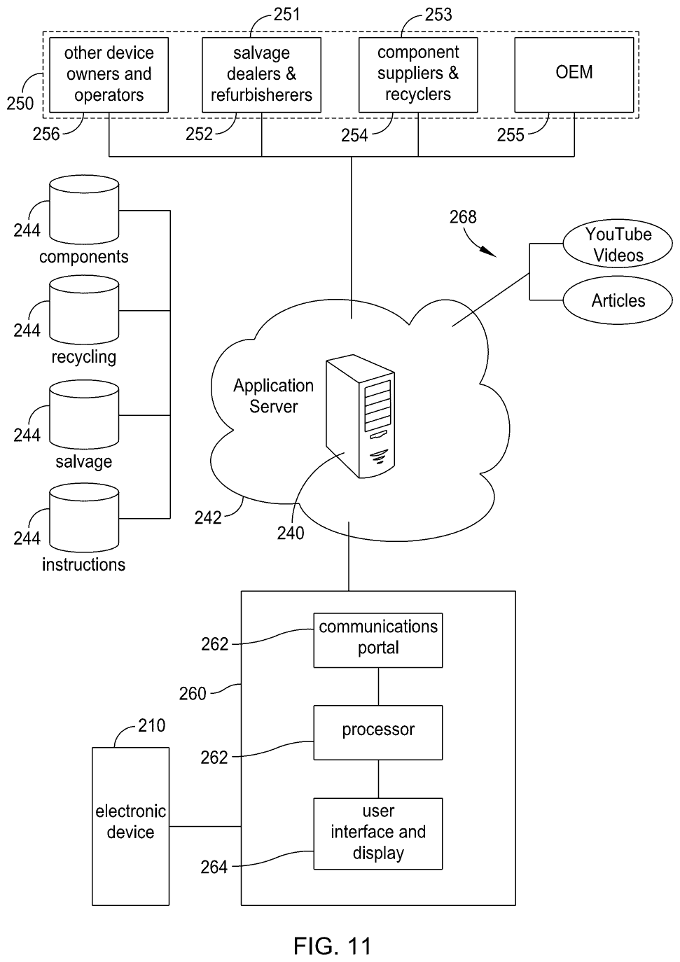

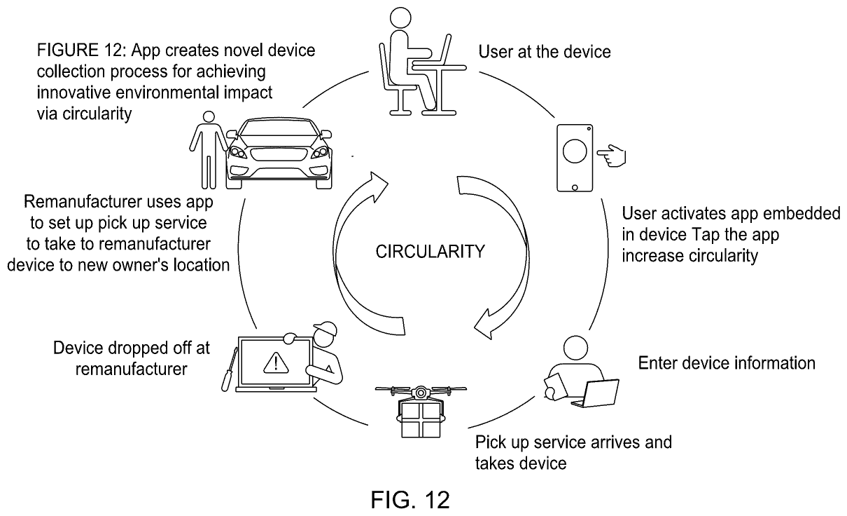

FIG. 11 illustrates a network diagram of an end-of-life application for transportation the electronic device, in accordance with an embodiment of the present disclosure. FIG. 12 illustrates the end-of-life application of FIG. 11 providing circularity for environmental impact for device transport.

With continued reference to the network diagram of FIG. 11 and the circularity diagram of FIG. 12, in various embodiments, there is described a method for transport of an end-of-life electronic device 210 from a device operator owning or operating the electronic device to one or more locations of a network of entities 250 to recycle device scrap of the end-of-life electronic device or to extend the life of the device.

The transport method may comprise initiating 291, through an executable end-of-life application, a logical session between the device operator and an application server 240 accessible through the internet 242. The executable application may be installed on a processor 262 of a communication device 260 of the device operator and may access the application server 240 via a communication portal 266 connected to the internet 242. The processor 262 may drive a user interface and display 264 for interacting with the device operator. Alternatively, the executable application may be integrated into or installed on the electronic device 210 itself, or may be integrated into the motherboard of the device. Advantageously, including the application in the electronic device itself installs longevity and sustainability into the device, and may be installed at the point of manufacture. Communication portal 266 may be an internet modem, WiFi router, cellular transceiver, or other means commonly used to access the internet.

The transport method may further comprise receiving from the device operator a request 292 for information regarding one or more of a transportation options of the end-of-life electronic device, a list of refurbishers, a list of recycling entities, and a price and availability of a repair component. The method may further comprise accessing 293 databases 244 connected to the application server 240 to retrieve the information arriving from at least one of the following entities communicative with the application server 240: a salvage dealer, a refurbisher, a recycling entity, and a component supplier.

The executable application may periodically receive from the entities 250 communicative with the server 240 and from communication device 260 of the device operator an update of transportation options for makes and models of the electronic devices supported by the databases 244 connected to the application server 240. The values may include price and availability. The entities 250 communicative with the application server 240 may also include at least one of an original equipment manufacturer (OEM) supplier 255 and other device operators 256. The exchange method may also comprise querying 294 the entities directly to fulfill the information request 292.

Finally, the method may include transmitting 295 to the device operator the information retrieved, where the requested information may be retrieved directly or indirectly from the network of entities 250. The method may further comprise deciding 296 whether there is an actionable transportation solution, based on the information retrieved. If there is an actionable solution, the method may further comprise communicating 297 with one or more of the entities to transfer the end-of-life device. The transfer may comprise a reciprocal transacting of funds through the application server in order to complete the exchange of the one or more components.

Continuing with FIGS. 11 and 12, the databases 244 connected to the application server 240 may include transportation instructions for at least one of disassembling, scrapping, recycling, and refurbishing the electronic device, and the request 292 for information may include the transportation instructions. The transportation instruction may include pointing to education links 268 including one or more of YouTube videos, articles, and OEM and component supplier price and availability data. If the deciding 296 determines that there is not an actionable transportation solution, the method may further include requesting 292 different information or the same information at a later time.

Beneficially, users of the executable application may quickly assess transportation options through a transparent exchange of information between one or more of the device operators, the salvage dealer, the refurbisher, the recycling entity, the component supplier, and the OEM. Once distributed to a sufficiently large number of users, the end-of-life application provides an impetus to move millions of end-of-life electronic devices stored, for example, in closets and basement into a commercial stream of entities communicative with the application server executing one or more of scrapping, recycling, refurbishing, repair, manufacturing, and retail exchange.

The end-of-life application may include an account setup and login routine to generate the network of entities and to thereby facilitate an economic exchange currently not available in the transportation and recycling environment. Some electronic devices may become obsolete, from the perspective of their owners or operators, because their appearance becomes marred. These marred or obsolete devices may have utility in other markets, or may be upgraded by refurbishers (remanufacturing) to be attractive and renewed in performance. Refurbishers may include non-profits who resell the electronic devices essentially unchanged to markets where the end-of-life devices are viewed as attractive in their appearance and modern in their performance.

Embodiments described herein provide an interactive environment for enabling a user to request on-demand pickup services using their device. In particular, some embodiments described herein enable mobile computing devices, such as smart phones and laptop devices, to be used in connection with an on-demand service that enables the device owner to request services, such as a delivery service or transport service, using a simplified user interface schematic. Functionality, such as communicating the location of the device owner, the location of available service providers, the types of service available, the estimated fees and other information, can be aggregated and provided to the user in an efficient and user-friendly manner.

In one embodiment, a computing device can operate an application (app) for requesting on-demand services. The application can provide user interface features that provide a device owner using the application with information for enabling the device owner to request a particular type of pickup service. For example, the device owner can be provided with a mechanism for selecting services and service types, as well as displaying information that may affect the decision of the user in making such selections.

According to some embodiments, the information and service options made available to the user can be region-specific. For example, different on-demand services and information about different services can be provided to the device owner based on the region that the user is located in. Thus, the service options made available to the device owner, as well as the information provided to the device owner regarding the service options can be made region specific.

In some embodiments, different user interface features can be provided, at least in part, by an application or program that is stored and operated on the device owner's computing device. The application can be configured to communicate with an on-demand service system that arranges pickup services between device owners and service providers (e.g., drivers for transporting the device, or drones to transport the device) to someone who will either purchase it, remanufacture, recycle, or repair it. For example, a buyer seeking to purchase a specific device, can request said specific device to be delivered to his or her office, and the on-demand service system can determine available device owners wishing to sell their specific device that satisfy the buyer's request and arrange for a specific device owner to sell and transport the device using the service. The user is enabled, via the user interface features, to make different selections for viewing specified information and for requesting different on-demand service options based on the user selections.

According to an embodiment, a location of the computing device can be determined so that user interface features for requesting an on-demand service can be presented, on a display of the computing device, based on the device's real-time location. A multistate selection feature can be provided to enable a user to select a particular type of pickup or drop off service. In one implementation, the multistate selection feature identifies a plurality of service options for an on-demand service (e.g., types of vehicles or drones that can provide a transport service for the user, types of trucks, delivery methods, etc.), based on a region where the user is located (e.g. the device's real-time location).

In one embodiment, a summary user interface can be presented on the display in response to the user (aka device owner (seller) or buyer) selecting one of the plurality of the service options, such as a vehicle type for a delivery or transport, or type of electronic device service. The summary user interface can include region-specific information about the on-demand service that is particular to and based on the selected service option. For example, for an on-demand device pick up service, the summary user interface can include region-specific information about the closest device buyer service providers, types of devices available in the region, average prices for the devices, the inventory available, etc. In another example, the region-specific information can include an estimated time of arrival to the user's current location, the average price, the amount of packaging options available of that particular vehicle, etc. The provided information can assist the user in making a better informed decision in requesting the on-demand service.

When a user makes a pickup service request, the user can specify a location or region related to the pickup service request. In one example, for a transport service request, the user can specify a pick-up location or region and/or a drop-off location or region via one or more user interface features provided by a service application. Based on the specified region, the service application and/or the on-demand service system can determine one or locations of interest. The service application and/or the on-demand service system can use the determined locations in order to determine a likely location for the device.

Still further, in some embodiments, once the user requests the on-demand pickup service based on the selected pickup service option, a confirmation user interface feature can be displayed to present additional features and information that the user can verify before confirming the request for pick up or delivery of the device. When the user confirms the request (e.g., places an order), the computing device can provide the pickup service request to the on-demand service system with necessary user data so that the on-demand service system can arrange the pickup service between the user and an available service provider to pick up or deliver the device. The user can provide additional information on the confirmation user interface feature, such as, for example, special notes for the service provider or a device identification number (DIN) that contains details specific to the device, e.g. model, year made, processor, screen size, operating system, etc. before confirming the request.

As described herein, a “user,” refers to individuals, e.g. device owners, device remanufacturers, device recyclers, device repairers, or device resellers that are requesting or ordering an on-demand pick up service of their device for sending to a predetermined location. Also as described herein, a “provider,” or a “service provider” refer to individuals or entities that can provide the requested pick up service. As an example, a user can request an on-demand service (e.g., car/Taxi service, FEDEX, UPS, drone service), using the app, and a service provider can communicate with the system (app) and/or the user to arrange to perform the service. In addition, as described herein, “user devices” refer to computing devices that can correspond to desktop computers, cellular or smartphones, personal digital assistants (PDAs), laptop computers, tablet devices, television (IP Television), etc., that can provide network connectivity and processing resources for enabling a user to communicate with a system over a network.

One or more embodiments described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more embodiments described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some embodiments described herein can generally require the use of computing devices, including processing and memory resources. For example, one or more embodiments described herein may be implemented, in whole or in part, on computing devices such as servers, desktop computers, cellular or smartphones, personal digital assistants (e.g., PDAs), laptop computers, printers, digital picture frames, network equipment (e.g., routers) and tablet devices. Memory, processing, and network resources may all be used in connection with the establishment, use, or performance of any embodiment described herein (including with the performance of any method or with the implementation of any system).

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, embodiments may be implemented in the form of computer-programs, or a computer usable carrier medium capable of carrying such a program.

### Example

As an example, a region-specific user interface feature can include a multistate selection panel. The multistate selection panel can include a multistate selection feature that can be manipulated and moved by the user (e.g., by interacting with an input mechanism or a touch-sensitive display screen) in order to select one or more service options to request the on-demand service. Based on the user's determined region, the multistate selection panel can identify and display only certain options that are available for providing the on-demand device pick up service in that region. For an on-demand transport service, for example, if a drone is unavailable in a particular region, such as Philadelphia, but many forms of vehicles including taxis, Uber, Lyft, or service providers like DoorDash, Nextdoor are available, the multistate selection panel can enable only the available vehicle types to be displayed and/or selected by the user. The indicators for the unavailable types of vehicles or service providers can be blocked out, hidden, or displayed in a different manner than indicators for vehicle types that are available in that region.

Similarly, in an example for on-demand very specific sought device, the multistate selection panel can provide different device types that are available for selection by a user in the region that are similar to the one sought. If a remanufactured device is unavailable for a particular region, while recycled devices are available for a user to request, the multistate selection panel can enable only recycled devices to be selected by the user in requesting the on-demand device service.

When the user interacts with the multistate selection feature, additional information corresponding to the selected pick up service option can be provided in a region-specific user interface feature. In one implementation, the user interface feature can correspond to a summary panel that displays region-specific information about the selected pick up service option. For example, for an on-demand device pickup service, once a user makes a selection of a type of service (e.g., Lyft, Uber, taxi, FEDEX, etc.), the summary panel can display information about the closest available pick up provider, the average cost for an order, pick up and delivery details, service provider profile information, or other information that the user can quickly view to make an informed decision.

In another example, for an on-demand transport pick up and drop off service, the summary panel can provide region-specific information, such as the estimated time of arrival for pickup (based on the user's current location or pickup location and the current locations of the available delivery options of the selected type), the average cost based on the region (e.g., the average estimated fare can be region-specific because some regions can be more expensive than other regions.

Once the user makes a selection by providing a user input, the application manager can cause the UI component to provide user interface features that are based on the selected service option. The user can then make a request for the on-demand pick up service based on the selection. In one example, when the user makes a request, a confirmation user interface feature can be provided by the on-demand service application. From this user interface feature, the user can view the details of the request, such as what account or credit card to charge (and can edit or choose a different payment method), provide specific requests to the driver, enter a promotional code for a discount, calculate the price, cancel the request, or confirm the request. As an alternative, the request can be automatically confirmed without displaying a confirmation user interface feature.

After the user confirms the request for the on-demand device pick up service, the on-demand service application can provide the service request to the on-demand service system via the service interface. In some examples, the service request can include the service location specified by the user (e.g., the location where the user would like the service to be performed or provided), the user's account information, the selected service option, any specific notes or requests to the service provider, and/or other information provided by the user. Based on the received pick up service request, the on-demand service system can arrange the pickup service between the user and an available service provider that is qualified and capable of providing the on-demand device pick up service.

It is contemplated for embodiments described herein to extend to individual elements and concepts described herein, independently of other concepts, ideas or system, as well as for embodiments to include combinations of elements recited anywhere in this application. Although embodiments are described in detail herein, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. Thus, the absence of describing combinations should not preclude the inventor from claiming rights to such combinations.

Although the above embodiments have been described in language that is specific to certain structures, elements, compositions, and methodological steps, it is to be understood that the technology defined in the appended claims is not necessarily limited to the specific structures, elements, compositions and/or steps described. Rather, the specific aspects and steps are described as forms of implementing the claimed technology. Since many embodiments of the technology can be practiced without departing from the spirit and scope of the invention, the invention resides in the claims hereinafter appended.

What is claimed is:

1. A method for transport using an end-of-life circularity transport application installed in an electronic device, the method comprising:
accessing an application server from a communications device of an operator of the electronic device, the communications device having a processor for operating an end-of-life circularity transport application installed on the processor and providing internet connectivity to the application server, the end-of-life circularity transport application capable of one or both of (1) driving a user interface configured to provide a set of transport instructions and (2) provide the transport instructions configured to a transport service;
determining a location relating to the transport service on a computing device, the method being performed by one or more processors and comprising:
receiving a transport request from a user, the transport request specifying at least one of a pick-up region or a drop-off region;
determining one or more locations of interests within the at least one of the pick-up region or the drop-off region;
comparing the at least one of the pick-up region or the drop-off region with one or more previous locations related to the user; and
determining a likely location based on the determined one or more locations of interest and the one or more historical locations.

2. The method of claim 1, further comprising:
in response to determining the likely location, providing a prompt on a user interface feature that asks the user whether the likely location is a location the user would like to have the device picked up at or dropped off at.

3. The method of claim 2, further comprising:
receiving a user confirmation that the likely location is the location the user would like to have the device picked up at or dropped off at; and
arranging the transport service for the user based on the likely location.

4. The method of claim 2, further comprising:
receiving a user input that specifies that the likely location is not the location the user would like to have the device picked up at or dropped off at; and
determining a second likely location based on the determined one or more locations of interest and the one or more historical locations.

5. A computing device comprising:
a display;
one or more memory resources;
one or more processors coupled to the display and the one or more memory resources, the one or more processors to:
access an application server having a processor for operating an end-of-life circularity transport application installed on the processor and providing internet connectivity to the application server, the end-of-life circularity transport application capable of one or both of (1) driving a user interface configured to provide a set of transport instructions and (2) provide the transport instructions configured to a transport service;
receive a transport request for a transport service from a user, the transport request specifying at least one of a pick-up region or a drop-off region;
determine one or more locations of interests within the at least one of the pick-up region or the drop-off region.

6. The app of claim 5, wherein the one or more processors further, in response to determining the likely location, provide a prompt on a user interface feature that asks the user whether the likely location is a location the user would like the electronic device to be picked up at or dropped off at.

7. The transport service of claim 5 comprises one of an Uber, Lyft, Doordash, Nextdoor, taxis, limo, shared ride service.

8. The pickup service in claim 5 is a drone UAV.
